(19) United States
(12) Patent Application Publication
(10) Pub. No.: US 2025/0043104 A1
(43) Pub. Date: Feb. 6, 2025

(54) MULTI-FUNCTIONAL POLYOL BORATE SALT COMPLEXES FOR HEAT STABILIZATION AND FLAME RETARDANCY OF VINYL POLYMERS

(71) Applicant: AKDENIZ CHEMSON KIMYA SANAYI VE TICARET ANONIM SIRKETI, Caddesi/Izmir (TR)

(72) Inventor: Dogan TAC, Sokak/Izmir (TR)

(21) Appl. No.: 18/717,223

(22) PCT Filed: Dec. 28, 2021
(86) PCT No.: PCT/TR2021/051547

§ 371 Date: Jun. 6, 2024

(51) Int. Cl. C08K 5/00; C07F 5/02

(52) U.S. Cl. CPC C08K 5/0091; C07F 5/022

(57) ABSTRACT

A multi-functional heat stabilizer and flame retardant complex comprises esters of at least one polyol-borate salt complex.

### TECHNICAL FIELD

The present invention relates to polyol-borate salt complexes function as both heat stabilizer and flame retardant in vinyl polymers, especially in soft PVC formulations, preparation of such salt complexes and use of such salt complexes as both heat stabilizer and flame retardant in soft PVC formulations.

### BACKGROUND OF THE INVENTION

Halogenated polymeric compounds such as polyvinyl chloride (PVC) have very poor resistance to heat. Due to low heat resistance of halogenated polymeric compounds, such situations like discoloration, brittleness and loss of strength may appear during various fabrication processes. In order to protect halogenated polymeric compounds from the aforementioned degradations caused by heat, many additives, known in the art as stabilizers, are utilized.

Within the known state of art, an example, which is related to boric acid-polyhydric alcohol complexes stabilizers for halogen containing polymeric resin formulations, is disclosed in U.S. Pat. No. 2,949,439A. In said patent document, the molar ratio of polyhydric alcohol to boric acid in reaction mixture is in the range from 1:8 to 8:1. In the U.S. Pat. No. 2,949,439A, although stabilization of halogen containing polymeric resins is tested, flame retardant properties of boric acid-polyol complexes, especially in soft PVC applications, have not been examined.

Moreover, in the article document named as “The synthesis of high yield diglycerin borate”, written by Qi Wang, Guo Zheng, Jianjie Ai and Xuejing Wei, the synthesis of diglycerin borate complex (DGB) by reacting glycerol and boric acid is disclosed. In the mentioned article document, the molar ratio of glycerol and boric acid is 2:1 and the yield of DGB reaches more than 96%. Additionally, in the said document, it is stated that obtained diglycerin borate complex is utilized as emulsifier, dispersant, preservative, water-insoluble stabilizer, anti-static agent and flame retardant in polymer materials. However, in the aforementioned article document, the heat stability and flame retardancy features of diglycerin borate complex in soft PVC formulations have not been stated.

### BRIEF DESCRIPTION OF THE INVENTION

The present invention provides a multi-functional heat stabilizer and flame retardant complex comprising esters of polyol-borate salt complex. In the present invention, the said esters of polyol-borate salt complex are obtained by a process comprising the steps of:
obtaining a polyol-borate complexes by mixing boric acid and at least one polyol compound in a reactor vessel wherein the molar ratio of said polyol compound to said boric acid is 2:1;
neutralising said polyol-borate complexes with at least one metal hydroxide to obtain polyol-borate salt complexes;
esterification of said polyol-borate salt complexes with at least one fatty acid esters to obtain esterified polyol-borate salt complexes.

Highly efficient polyol-borate salt complexes are obtained via the method provided by the present invention. In addition, the present invention provides use of the multi-functional polyol-borate salt complexes as heat stabilizer and flame retardant in PVC formulations. Thus, heat stability and flame retardancy in Ca/Zn based soft PVC formulations are provided by the polyol-borate salt complexes.

### OBJECT OF THE INVENTION

An object of the present invention is to provide a method for preparing polyol-borate salt complexes and their uses.

Another object of the present invention is to provide multi-functional heat stabilizer and flame retardant polyol-borate salt complexes for heat stabilization and flame retardancy of vinyl polymers.

Another object of the present invention is to provide a highly efficient method for preparing polyol-borate salt complexes.

### DESCRIPTION OF THE INVENTION

Halogenated polymeric compounds such as polyvinyl chloride or copolymers of polyvinyl chloride have very poor resistance to the effects of heat. During various fabrication processes, low heat resistance of halogenated polymeric compounds causes discoloration, brittleness and loss of strength of polymeric compounds. To protect halogenated polymeric compounds from the mentioned degradations caused by heat, many additives, known in the art as stabilizers, are used. In the state of art, various processes for the preparation of these stabilizers are developed. However, the aforementioned stabilizers do not provide both heat stability and flame retardant properties for polymeric compounds as it is needed. Therefore, in the present invention, a multi-functional heat stabilizer and flame retardant complex, a method for preparing such complexes and use of said complexes as both heat stabilizer and flame retardant are provided in order to solve the above mentioned-problems.

According to present invention, a multi-functional heat stabilizer and flame retardant complex comprises esters of polyol-borate salt complex. In the present invention, the aforementioned esters of polyol-borate salt complex are obtained by a process comprising the steps of:
obtaining a polyol-borate complexes by mixing boric acid and at least one polyol compound in a reactor vessel wherein the molar ratio of said polyol compound to said boric acid is 2:1;
neutralising said polyol-borate complexes with at least one metal hydroxide to obtain polyol-borate salt complexes;
esterification of said polyol-borate salt complexes with at least one fatty acid esters to obtain esterified polyol-borate salt complexes.

In a preferred embodiment of the invention, boric acid and at least one polyol compound are placed in a reactor vessel to obtain reaction mixture. The molar ratio of said polyol compound to said boric acid is 2:1. The temperature of the obtained reaction mixture is increased to a first temperature (preferably 140° C.-160° C., in particular 150° C.) under vacuum atmosphere (preferably under 550 mmHg-650 mmHg, in particular 600 mmHg) to carry out the synthesis reaction of polyol-borate complexes. Then, water formed in the said reaction mixture is separated from the said reaction mixture via dean-stark apparatus. The said reaction mixture, separated from water, is cooled to a second temperature (preferably 45° C.-55° C., in particular 50° C.) and is diluted with water. In order to neutralize the said reaction mixture, at least one metal hydroxide (preferably selected from LiOH, NaOH, KOH, Mg(OH) 2 and/or Ca(OH) 2, in particular Mg(OH) 2) is added into the said reaction mixture at the said second temperature with continuous stirring. The molar ratio of said polyol-borate complex to said at least one metal hydroxide is in the range from 1:1 to 1:4. After evaporation of water from the said reaction mixture, a polyol-borate salt complex is obtained. The aforementioned polyol-borate salt complex is added into at least one fatty acid ester heated under inert atmosphere to a third temperature (preferably 110° C.-130° C., in particular 120° C.) for esterification of the polyol-borate salt complex. The said at least one fatty acid ester has the formula CH₃(CH₂)ₙ—CO wherein n is in the range from 6 to 22. The obtained polyol-borate salt complex and said fatty acid ester are mechanically mixed at the third temperature and then, at least one metal catalyst is added. After all, esterified borate-polyol salt complex is obtained.

In a preferred embodiment of the invention, the aforementioned polyol compound does not have more than 4 hydroxyl groups so it is preferably selected from glycerol, pentaerythritol, ethylene glycol, propylene glycol, butylene glycol, diethylene glycol and/or triethylene glycol in particular glycerol. Additionally, the molar ratio of at least one polyol compound to boric acid in reaction mixture is 2:1.

In an exemplary embodiment of the invention, the polyol compound is glycerol. In order to obtain reaction mixture, boric acid and glycerol are placed in a reactor vessel and the temperature of the obtained reaction mixture is increased to 150° C. under vacuum atmosphere to carry out the synthesis reaction of glycerol boric acid complex.

The synthesis reaction mechanism of glycerol boric acid complex is given as below;

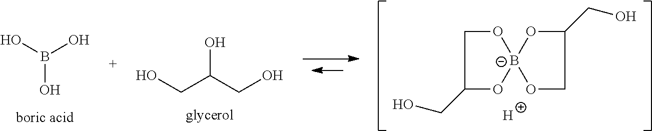

Then, water formed in the said reaction mixture is separated from the said reaction mixture via dean-stark apparatus and the said reaction mixture, separated from water, is cooled to 50° C. and is diluted with water. In order to neutralize the said reaction mixture, at least one metal hydroxide (preferably Mg(OH) 2) is added into the said reaction mixture at 50° C. with continuous stirring. After evaporation of water from the said reaction mixture, the glycerol borate salt complex is obtained. The neutralization reaction of glycerol borate complex with metal hydroxide is given as below;

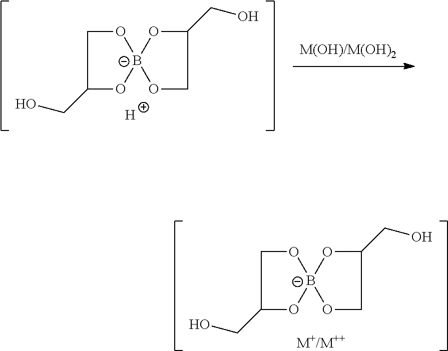

The obtained glycerol borate salt complex is slowly added into fatty acid esters, heated under inert atmosphere to 120° C., for esterification of the glycerol borate salt complex and they are mechanically mixed at 120° C. In order to increase the rate of esterification of fatty acids with glycerol borate salt complex, at least one metal catalyst is added and then, esterified borate-polyol salt complex is obtained. The esterification reaction of glycerol borate salt complex with fatty acids is given as below;

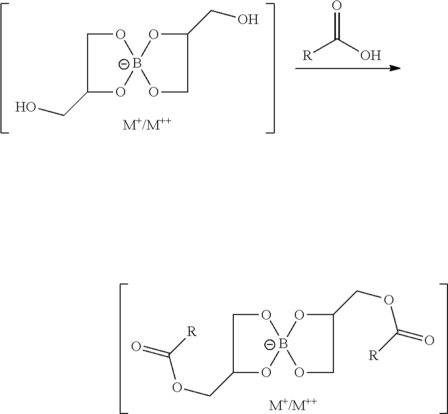

Highly efficient polyol-borate salt complexes are obtained via method provided by the present invention. The aforementioned polyol-borate salt complexes are utilized as multi-purpose additives for halogenated resin formulations, especially in highly plasticized PVC formulations. The aforementioned borate-polyol salt complexes obtained by the said method provide both heat stability and flame retardancy especially in Ca/Zn based soft PVC formulations.

1. A multi-functional heat stabilizer and flame retardant complex wherein the complex comprises esters of at least one polyol-borate salt complex.

2. A method of obtaining esters of at least one polyol-borate salt complex for a multi-functional heat stabilizer and flame retardant complex, comprising the steps of:
obtaining a polyol-borate complexes by mixing boric acid and at least one polyol compound in a reactor vessel wherein the molar ratio of said polyol compound to said boric acid is 2:1;
neutralising said polyol-borate complexes with at least one metal hydroxide to obtain polyol-borate salt complexes; and
esterification of said polyol-borate salt complexes with at least one fatty acid ester to obtain esterified polyol-borate salt complexes.

3. The method according to claim 2, wherein said at least one polyol compound is selected from glycerol, pentaerythritol, ethylene glycol, propylene glycol, butylene glycol, diethylene glycol and/or triethylene glycol.

4. The method according to claim 3, wherein said at least one polyol compound is glycerol.

5. The method according to claim 2, wherein said at least one metal hydroxide is selected from LiOH, NaOH, KOH, Mg(OH)2 and/or Ca(OH)2.

6. The method according to claim 5, wherein said at least one metal hydroxide is Mg(OH)2.

7. The method according to claim 2, wherein the molar ratio of said polyol-borate complex to said at least one metal hydroxide is in the range from 1:1 to 1:4.

8. The method according to claim 2, wherein said at least one fatty acid ester has the formula CH3(CH2)n-CO wherein n is in the range from 6 to 22.

9. A halogen-containing polymer comprising the multi-functional heat stabilizer and flame retardant complex according to claim 1.

10. The halogen-containing polymer according to claim 9, wherein said halogen-containing polymer comprises polyvinyl chloride (PVC).

11. The halogen-containing polymer according to claim 9, wherein said halogen-containing polymer comprises soft polyvinyl chloride (PVC).
